(19) United States
(12) Patent Application Publication
(10) Pub. No.: US 2022/0343235 A1
(43) Pub. Date: Oct. 27, 2022

(54) SYSTEMS AND METHODS FOR IDENTIFYING RISKS OF MODERN SLAVERY

(71) Applicant: FAIR SUPPLY ANALYTICS PTY LIMITED, Coffs Harbor, New South Wales (AU)

(72) Inventors: Kimberly RANDLE, Coffs Harbor (AU); Arne GESCHKE, Sydney (AU); Jeff NAGLE, Bateau Bay (AU); Josiah FAJARDO, Alice Springs (AU)

(21) Appl. No.: 17/634,860

(22) PCT Filed: Aug. 14, 2020
(86) PCT No.: PCT/AU2020/050851

§ 371 Date: Feb. 11, 2022

(30) Foreign Application Priority Data
Aug. 16, 2019 (AU) 2019902979

(51) Int. Cl. G06Q 10/06

(52) U.S. Cl. CPC G06Q 10/0635; G06Q 10/06315; G06Q 40/06

(57) ABSTRACT

The presently disclosed subject matter generally relates to the field of supply chain analysis. Particularly, the present subject matter relates to a system and method for identifying risks of modern slavery in a complete system of supply chains, such as, for example, a risk assessment system for identifying one or more risks of modern slavery in at least one of operations of a company and associated complete system of upstream supply chains.

### TECHNICAL FIELD

The presently disclosed subject matter generally relates to the field of supply chain analysis. Particularly, the present subject matter relates to a system and method for identifying risks of modern slavery in a complete system of supply chains.

### BACKGROUND

Any references to methods, apparatus or documents of the prior art are not to be taken as constituting any evidence or admission that they formed, or form part of the common general knowledge.

A supply chain is a multi-tiered network of economic entities that exchange goods and services for monetary compensation. The final recipient of the supply chain is called the final consumer, all other entities are suppliers. The final consumer can be a company or multiple companies which may also act as suppliers and produce and distribute a specific product or service. The supply chain includes multiple functions like product development, marketing, operations, distribution, finance, customer service, and so forth. The management of the flow of goods and services is called supply chain management and may involve the movement and storage of raw materials of work-in-process inventory, and of finished goods from a point of origin to a point of consumption. Many of the products that we buy and use in our everyday life are directly or indirectly made by people in slavery. Based on various studies, it is evident that there is slavery in different stages of supply chains from the production of raw materials, for example cotton, cocoa, or fishing, to manufacturing every-day goods such as garments, electronic devices like mobile phones, computers, and even at the final stage, when the final product reaches the market.

The final products reach the market for purchase by end users after passing through a long chain of producers, manufacturers, distributors and retailers who have all participated in its production, delivery and sale. It can be very difficult to track a component of an end product back to a particular producer, for example to trace the cocoa used in a chocolate back to a particular cocoa farm and to quantify the contribution of each intermediary that buys and on-sells the cocoa. Supply chains are often complex, counter-intuitive and often have a global reach, which in turn makes it almost impossible to be certain that a product has or has not been produced using slavery. Further, many challenges including lower prices, short turnaround times etc. imposed by companies on their suppliers can increase the likelihood that forced labour or slavery was used in the processes resulting in the final product. For example, the short turnaround expectations of a company may force suppliers to involve other suppliers or factories that may not be regulated by acceptable standards. Further, sometimes the company may negotiate such low prices that suppliers may have to forcibly push down the costs of production, which in turn may have a bad effect on those who are involved in production of raw materials, hence increasing the risks of forced labour.

Slavery still exists today in more than 130 countries in one form or another. Modern day slavery or modern slavery refers to any form of forced human exploitation for labour or service, like forced labour, child labour, slavery, servitude, forced marriage, deceptive recruiting, debt bondage, or human trafficking.

There exist a number of technologies that attempt to provide a ‘footprint’ of slavery for company supply chains either by decomposing individual products or by classifying risk in different industries. The existing methods for identifying slavery footprints include product or industry-based risk assessment. The product-based slavery footprints methods (sometimes called bottom-up life cycle assessment methods) suffer from multiple limitations for example, they require companies to provide information about the precise products purchased from each supplier, and they require a significant amount of proprietary information from third parties about the components of each product, which can make the method prohibitively expensive or impossible if this commercial information is not disclosed. Furthermore, product-based slavery footprint methods involve significant assumptions about the origin of product components. An issue with existing methods is the system boundary problem and they usually stop at tier 2, or 3, and tier 6 can only be achieved for selective supply chains.

Industry-based risk assessment methods on the other hand are extremely limited in that they rely upon assessments of particular industries and countries and do not take into account the quantitative inputs of goods and services into those industries and countries. They can therefore at best only provide an estimate of the risks of slavery in the first or second tier of a supply chain. In light of the above discussion, there exists need for improved techniques for assessing risks of forced labour, slavery or modern slavery in a full system of supply chains.

### SUMMARY

To overcome the above-mentioned limitations and problems, the present disclosure provides a system and method for assessing and identifying risks of modern slavery in a complete system of supply chains.

The present disclosure provides a system for assessing one or more risks of modern slavery by identifying product risks, service risks and entity risks of modern slavery in operations of a company and supply chains of an organization, a sector, and industry risks. The supply chains can belong to any kind of economic unit such as an individual, a company, a group of people such as a certain region, socio-economic class, or even an entire country or group of countries.

The present disclosure provides a method for assessing one or more risks of modern slavery by identifying product risks, service risks and entity risks of modern slavery in operations of a company and supply chains of an organization, a sector and industry risks.

An embodiment of the present disclosure provides a risk assessment system for identifying one or more risks of modern slavery in at least one of operations of a company and associated complete system of upstream supply chains. The risk assessment system (or a system) includes an input module configured to receive at least one of a first set of inputs and a second set of inputs. The first set of inputs includes data from publicly available data sources or any other data source. The non-limiting examples of other data sources may include categorical risk estimates of modern slavery in a plurality of industries independent of a country of origin based on manual input from a user. The second set of inputs includes at least one of a spend dataset, and a portfolio investment profile dataset of at least one company. The system also includes a matrix generation module configured to dynamically generate a risk matrix comprising the one or more risk estimates of modern slavery in a plurality of industries and countries based on the first set of inputs. The one or more risk estimates of modern slavery for industries independent of country of origin may be an input received by the input module. The system also includes a slavery assessment module configured to convert the second set of inputs into a suitable format compatible with a multi-region input-output (MRIO) table; and generate one or more supply chain risk estimates of the modern slavery based on the generated risk matrix, the MRIO table, and formatted second set of inputs and by using one or more standard supply chain decomposition and foot printing methods. The system also includes a display module configured to present the generated one or more supply chain risk estimates of the modern slavery.

In some embodiments, the one or more supply chain risk estimates may include a percentage of the total modern slavery risk that occurs in upper tiers of the supply chain of a given industry, and a percentage of the total value chain represented by the same segment of the supply chain. The one or more supply chain risk estimates may provide insight about the nature of the modern slavery risk in relation to the first-tier industry, i.e. how closely connected the first-tier industry is to modern slavery and how much leverage it has.

In some embodiments, the second set of inputs may include investment portfolio, loan portfolio, or sovereign bond data of the at least one company.

The system may be configured to convert the second set of inputs (i.e. the investment/loan amounts) into ‘equivalent final demand’ amounts using the publicly available datasets i.e. the first set of inputs. The non-limiting examples of the publicly available datasets may include the average annual revenue to enterprise value ratio of a given industry in a given region, the Gross Domestic Product of countries, and the total public debt of countries. Furthermore, when it is either spend dataset or investment dataset that is being converted, the system may use basic price to purchaser's price ratio as part of the conversion of the data to a form compatible with the MRIO table. The basic price to purchaser's price ratios can be sourced from any suitable dataset such as, but not limited to, the MRIO dataset.

According to an aspect of the present disclosure, the matrix generation module is further configured to dynamically update the one or more risk estimates of modern slavery of the risk matrix based on one or more updates in the first set of inputs.

According to another aspect of the present disclosure, the matrix generation module is further configured to extrapolate the first set of inputs to generate estimates about countries and industries with lower levels of information.

According to another aspect of the present disclosure, the matrix generation module is further configured to combine one or more data inputs of the first set of inputs into a risk estimate matrix comprising a relative number of forced labourers in each industry and country.

According to another aspect of the present disclosure, the matrix generation module is further configured to compare a forced labour risk of one or more industries in a plurality of countries based on the risk estimate matrix of the one or more industries in the plurality of countries.

According to another aspect of the present disclosure, the one or more supply chain risk estimates of the modern slavery further comprises data about a company's suppliers/investments having the greatest risk of forced labour in their supply chain, a tier related data about one or more tier of the company's supply chain having a greatest risk of forced labour, an industry/country specific data including countries and industries having the greatest risk over the entire supply chain, and a suppliers' data about suppliers contributing to the greatest overall risks.

According to another aspect of the present disclosure, the slavery assessment module is further configured to convert the second set of inputs (i.e. the investment/loan amounts) into ‘equivalent final demand’ amounts using the first set of inputs.

According to another aspect of the present disclosure, the matrix generation module is further configured to combine one or more input data comprising an employment dataset, prevalence estimates, a government response, a product information, and an industry risk to derive a useable relative risk rating of forced labour risk for each country and industry.

According to another aspect of the present disclosure, the second set of inputs is converted into the format compatible with the MRIO table by using at least one of prorating of spend or investment amounts by industry economic output figures derived from the MRIO table, standard automated database manipulation techniques, and input-output analysis techniques.

According to another aspect of the present disclosure, the risk assessment system also includes a database configured to store, update and maintain at least one of the first set of inputs, the second set of inputs, the risk matrix, the overall risk data for supply chains, the MRIO table, the employment data, the prevalence estimates, the government response, the product information, and the industry risk.

According to yet another aspect of the present disclosure, the one or more risk estimates of modern slavery in different industries and countries are determined manually.

Another embodiment of the present disclosure provides a method for identifying one or more risks of modern slavery in at least one of operations of a company and associated complete system of upstream supply chains. The method includes receiving, by an input module of a risk assessment system, at least one of a first set of inputs and a second set of inputs, wherein the first set of inputs comprising data from publicly available data sources, wherein the second set of inputs comprising at least one of a spend dataset and a portfolio investment profile dataset of at least one company. The method also includes dynamically generating, by a matrix generation module of the risk assessment system, a risk matrix comprising one or more risk estimates of modern slavery in a plurality of industries and countries based on the first set of inputs. The one or more risk estimates of modern slavery for industries independent of country of origin may be an input received by the input module. The method also includes converting, by a slavery assessment module of the risk assessment system, the second set of inputs into a format compatible with a multi-region input-output (MRIO) table. The method also includes generating, by the slavery assessment module, one or more supply chain risk estimates of the modern slavery based on the generated risk matrix, the MRIO table, and formatted second set of inputs and by using one or more standard supply chain decomposition and foot printing methods. The method also includes presenting, by a display module of the risk assessment system, the generated one or more supply chain risk estimates of the modern slavery.

According to an aspect of the present disclosure, the method also includes dynamically updating, by the matrix generation module, the one or more risk estimates of modern slavery of the risk matrix based on one or more updates in the first set of inputs.

According to another aspect of the present disclosure, the method also includes extrapolating, by the matrix generation module, the first set of inputs to generate estimates about countries and industries with lower levels of information.

According to another aspect of the present disclosure, the method also includes combining, by the matrix generation module, one or more data inputs of the first set of inputs into a risk estimate matrix comprising a relative number of forced labourers in each industry and country.

According to another aspect of the present disclosure, the method also includes comparing, by the matrix generation module, a forced labour risk of one or more industries in a plurality of countries based on the risk estimate matrix of the one or more industries in the plurality of countries.

According to another aspect of the present disclosure, wherein the one or more supply chain risk estimates of the modern slavery comprises a percentage of the total modern slavery risk that occurs in upper tiers of the supply chain of a given industry, a percentage of the total value chain represented by the same segment of the supply chain, data about a company's suppliers/investments having the greatest risk of forced labour in their supply chain, a tier related data about one or more tier of the company's supply chain having a greatest risk of forced labour, an industry/country specific data including countries and industries having the greatest risk over the entire supply chain, and a suppliers' data about suppliers contributing to the greatest overall risks.

According to another aspect of the present disclosure, the method also includes converting, by the slavery assessment module, the second set of inputs (i.e. the investment/loan amounts) into ‘equivalent final demand’ amounts using the first set of inputs.

According to another aspect of the present disclosure, the method also includes combining, by the matrix generation module, one or more input data comprising an employment dataset, prevalence estimates, a government response, a product information, and an industry risk to derive a useable relative risk rating of a forced labour risk for each country and industry.

According to another aspect of the present disclosure, the method also includes storing, updating and maintaining, in a database of the risk assessment system, at least one of the first set of inputs, the second set of inputs, the risk matrix, the overall risk data for supply chains, the MRIO table, the employment data, the prevalence estimates, the government response, the product information, and the industry risk.

According to another aspect of the present disclosure, the method also includes manually determining the one or more risk estimates of modern slavery in different industries and countries.

According to further aspect of the present disclosure, the first set of inputs comprising at least one of Global Slavery Index estimates of a number of slaves in each country and a percentage of slaves that are forced labourers in each region, US Department of Labor findings of particular products and countries that are known to involve the use of forced or child labour, the US Department of State Trafficking in Persons (TIP) Report that categorizes countries based on their response to human trafficking, and estimates of the number of employees in each industry and the economic output of each industry in each country from a dataset.

According to another aspect of the present disclosure, the second set of inputs into may be converted into a format compatible with a multi-region input-output (MRIO) table by using a suitable method such as, but not limited to, an MRIO foot printing method to a social indicator.

In some embodiments, the second set of inputs are converted into the format compatible with the MRIO table by using at least one of prorating of spend or investment amounts by industry economic output figures derived from the MRIO table, standard automated database manipulation techniques, and input-output analysis techniques.

According to another aspect of the present disclosure, the risk matrix comprises a satellite account for the MRIO matrix (Q matrix).

Other and further aspects and features of the disclosure will be evident from reading the following detailed description of the embodiments, which are intended to illustrate, not limit, the present disclosure.

### DETAILED DESCRIPTION

Preferred features, embodiments and variations of the invention may be discerned from the following detailed description which provides sufficient information for those skilled in the art to perform the invention. The detailed description is not to be regarded as limiting the scope of the preceding summary of the invention in any way.

The functional units described in this specification have been labelled as devices or modules. A device or module may be implemented in programmable hardware devices such as CPUs, tensor processors, field programmable gate arrays (FPGA), cloud computation units, distributed computation units, or the like. The devices and modules may also be implemented in software for execution by various types of processors. An identified device or module may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Furthermore, the described features, structures, or characteristics may be combined in any suitable manner in one or more embodiments.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP/S, XML, SOAP, REST, JSON, MQTT, RTSP, HLS, TLS, SSL and other sufficient protocols. The disclosed computer programs can be written in complied programming languages that execute from memory on the device or from a hosted server, such as C, C++, Java, or interpreted languages such as JavaScript, Python, HTML, CSS, node.js, .net core, Ruby, PHP, Perl or other sufficient programming languages. Other software technologies like, ReactJS/Redux, visual studio code, WebStorm, NPM 4+, PostgreSQL database, DynamoDB, WebSocket, AWS, may be used to develop the disclosed system.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

Specific embodiments of the present disclosure are described, by way of example only, with reference to the accompanying drawings, in which:

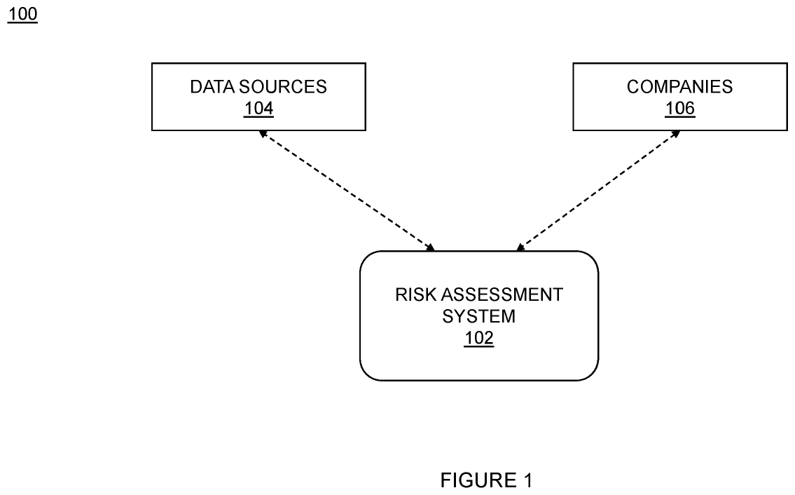

FIG. 1 is a schematic diagram illustrating an exemplary environment 100, where various embodiments of the present disclosure may function;

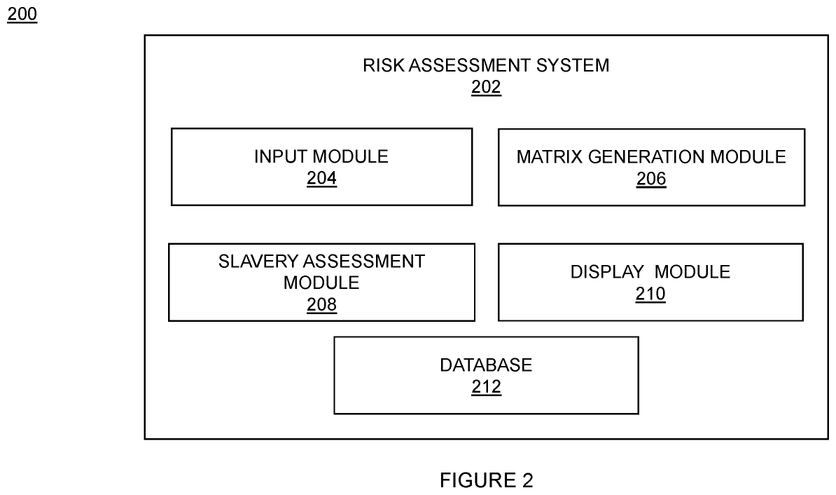

FIG. 2 is a block diagram 200 illustrating various system elements of an exemplary risk assessment system 202, in accordance with an embodiment of the present disclosure;

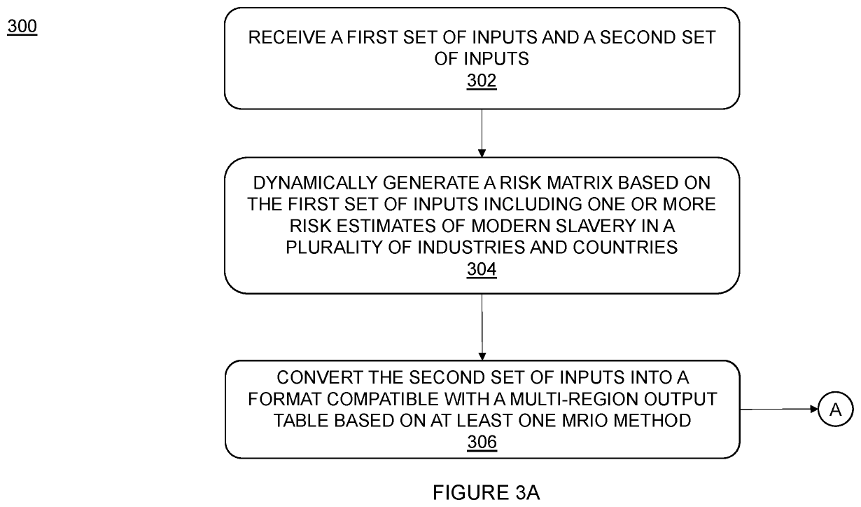

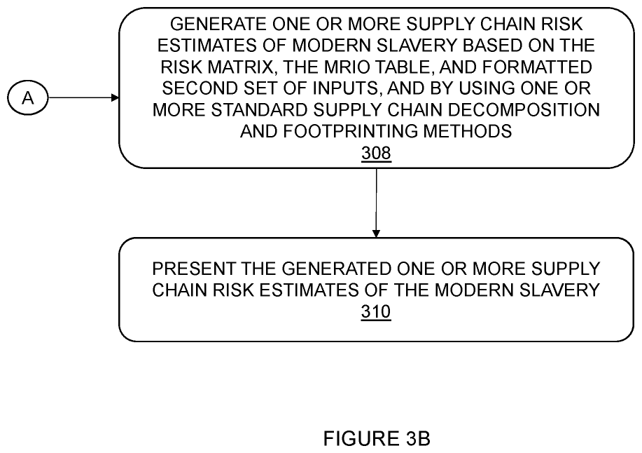

FIGS. 3A-3B is a flowchart diagram illustrating an exemplary method 300 for identifying one or more risks of modern slavery in at least one of operations of a company and a complete supply chain, in accordance with an embodiment of the present disclosure.

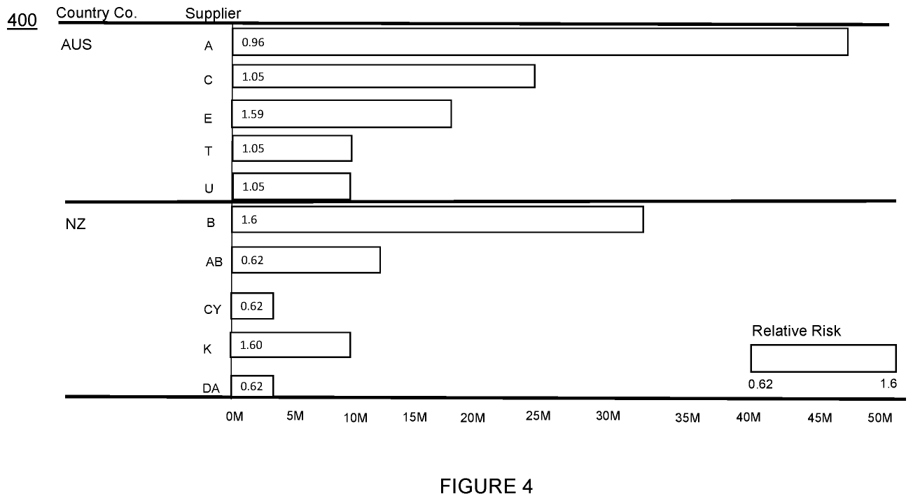

FIG. 4 illustrates an exemplary graph 400 showing risks by supplier in a supply chain (relative), in accordance with an embodiment of the present disclosure;

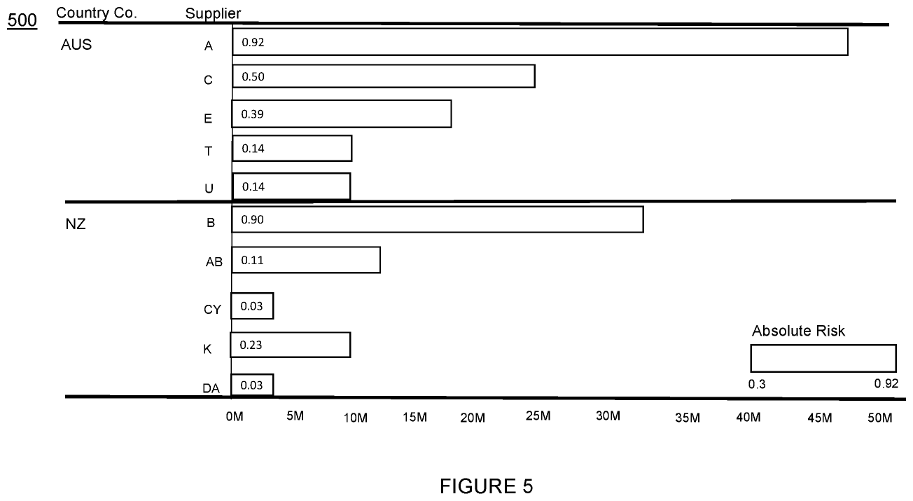

FIG. 5 illustrates another exemplary graph 500 depicting risk(s) by supplier (absolute), in accordance with an embodiment of the present disclosure; and

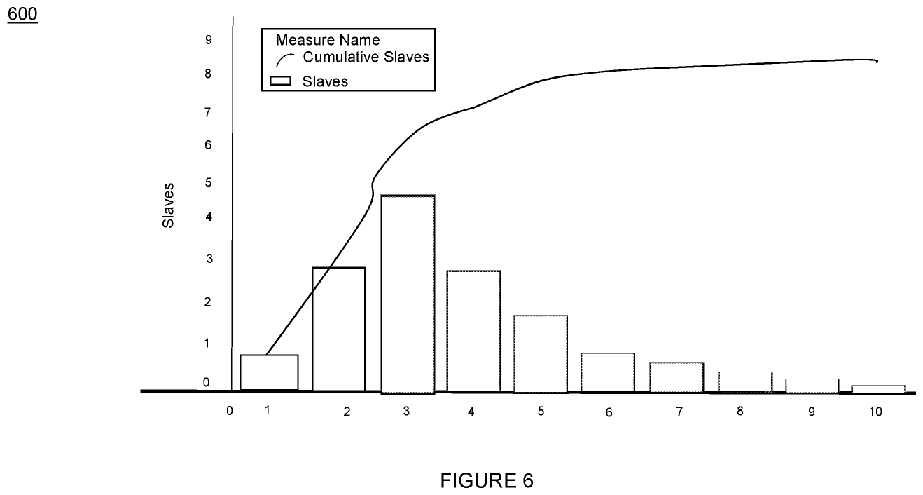

FIG. 6 illustrates another exemplary graph 600 depicting slaves and cumulative slaves by tier, in accordance with an embodiment of the present disclosure.

As used herein, the term “risk assessment system” refers to a device (or module) or a combination of one or more devices (or modules) configured to identify one or more risks of modern slavery in at least one of operations of a company and associated complete system of upstream supply chains (or complete system of supply chains). The non-limiting examples of the risks of modern slavery may include, but are not limited to, risks of forced labour, risks of slavery, and so forth. The risk assessment system may include hardware, software, firmware, or combination of these. The risk assessment system is configured to: receive at least one of a first set of inputs and a second set of inputs, wherein the first set of inputs comprising data from publicly available data sources, wherein the second set of inputs comprising at least one of a spend dataset and a portfolio investment profile dataset of at least one company; dynamically generate a risk matrix comprising one or more risk estimates of modern slavery in a plurality of industries and countries based on the first set of inputs; convert the second set of inputs into a format compatible with a multi-region input-output (MRIO) table; generate one or more supply chain risk estimates of the modern slavery based on the generated risk matrix, the MRIO table, and formatted second set of inputs and by using one or more standard supply chain decomposition and foot printing methods; and present the generated one or more supply chain risk estimates of the modern slavery. In some embodiments, the risk assessment system is also configured to dynamically update the one or more risk estimates of modern slavery of the risk matrix based on one or more updates in the first set of inputs. Further, the risk assessment system may extrapolate the first set of inputs to generate estimates about countries and industries with lower levels of information. Further, the risk assessment system may be configured to combine one or more data inputs of the first set of inputs into a risk estimate matrix comprising a relative number of forced labourers in each industry and country. In some embodiments, the risk assessment system may also be configured to compare a forced labour risk of one or more industries in a plurality of countries based on the risk estimate matrix of the one or more industries in the plurality of countries. In some embodiments, the risk assessment system is further configured to combine one or more input data comprising an employment dataset, prevalence estimates, a government response, a product information, and an industry risk to derive a useable relative risk rating of forced labour risk for each country and industry.

In some embodiments, the one or more supply chain risk estimates may include a percentage of the total modern slavery risk that occurs in upper tiers of the supply chain of a given industry, a percentage of the total value chain represented by the same segment of the supply chain, data about a company's suppliers/investments having the greatest risk of forced labour in their supply chain, a tier related data about one or more tiers of the company's supply chain having a greatest risk of forced labour, an industry/country specific data including countries and industries having the greatest risk over the entire supply chain, and a suppliers' data about suppliers contributing to the greatest overall risks. The one or more supply chain risk estimates may provide insight about the nature of the modern slavery risk in relation to the first-tier industry, i.e. how closely connected the first-tier industry is to modern slavery and how much leverage it has

As used herein, the term “first set of inputs” refers to one or more data from publicly available data sources and the first set of inputs may be used for determining risks of modern slavery. The non-limiting examples of the first set of inputs may include such as, but not limited to, Global Slavery Index estimates of a number of slaves in each country and a percentage of slaves that are forced labourers in each region, US Department of Labor findings of particular products and countries that are known to involve the use of forced or child labour, the US Department of State Trafficking in Persons (TIP) Report that categorizes countries based on their response to human trafficking, and estimates of the number of employees in each industry and the economic output of each industry in each country from a dataset. The first set of inputs may be manually entered into the risk assessment system. Alternatively, the first set of inputs may be automatically requested and received by the risk assessment system.

As used herein, the term “second set of inputs” refers to data received by the risk assessment system for determining one or more risks of modern slavery. The second set of inputs may include a spend dataset and a portfolio investment profile dataset of at least one company. The second set of inputs may be manually entered into the risk assessment system. Alternatively, the second set of inputs may be automatically requested and received by the risk assessment system. In some embodiments, the second set of inputs may include investment portfolio, loan portfolio, or sovereign bond data of the at least one company.

Further, as used herein, the term “input module” refers to a single device (or module) or a combination of multiple devices (or modules) configured to receive at least one of a first set of inputs and a second set of inputs, wherein the first set of inputs comprising data from publicly available data sources, wherein the second set of inputs comprising at least one of a spend dataset and a portfolio investment profile dataset of at least one company. The input module may include hardware, software, firmware, and combination of these.

Further, as used herein, the term “matrix generation module” refers to a single device (or module) or a combination of multiple devices (or modules) configured to dynamically generate a risk matrix comprising one or more risk estimates of modern slavery in a plurality of industries and countries based on the first set of inputs. The matrix generation module may further be configured to dynamically update the one or more risk estimates of modern slavery of the risk matrix based on one or more updates in the first set of inputs. The matrix generation module may also be configured to extrapolate the first set of inputs to generate estimates about countries and industries with lower levels of information. The matrix generation module may also be configured to combine one or more data inputs of the first set of inputs into a risk estimate matrix comprising a relative number of forced labourers in each industry and country. In some embodiments, the matrix generation module is further configured to compare a forced labour risk of one or more industries in a plurality of countries based on the risk estimate matrix of the one or more industries in the plurality of countries. The matrix generation module may include hardware, software, firmware, and combination of these.

In some embodiments, the risk matrix may refer to a data matrix including values representing one or more risk estimates of modern slavery in a plurality of industries and countries. Further, the one or more risk estimates of modern slavery in different industries and countries may be determined manually. In some embodiments, the risk matrix may comprise a satellite account for the MRIO matrix (Q matrix).

Further, as used herein, the term “slavery assessment module” refers to a single device (or module) or a combination of multiple devices (or modules) configured to convert the second set of inputs into a format compatible with a multi-region input-output (MRIO) table; and generate one or more supply chain risk estimates of the modern slavery based on the generated risk matrix, the MRIO table, and formatted second set of inputs and by using one or more standard supply chain decomposition and foot printing methods. In some embodiments, the matrix generation module is further configured to combine one or more input data comprising an employment dataset, prevalence estimates, a government response, a product information, and an industry risk to derive a useable relative risk rating of forced labour risk for each country and industry. The slavery assessment module is further configured to convert the second set of inputs (i.e. the investment/loan amounts) into ‘equivalent final demand’ amounts using the first set of inputs. The slavery assessment module may include hardware, software, firmware, and combination of these.

Further, as used herein, the term “display module” refers to a single device (or module or a combination of multiple devices (or modules) configured to present the generated one or more supply chain risk estimates of the modern slavery. The display module may include hardware, software, firmware, and combination of these. In some embodiments, the display module may present the one or more supply chain risk estimates on a display screen.

Furthermore used herein, the term “database” refers to a storage device or module configured to store, update and maintain at least one of the first set of inputs, the second set of inputs, the risk matrix, the overall risk data for supply chains, the MRIO table, the employment data, the prevalence estimates, the government response, the product information, and the industry risk. The database may be a local storage device or a remotely located storage device. In some embodiments, the database may be a centrally located server. The database may include hardware, software, firmware, and combination of these.

Further as used herein, the term “company” refers to a commercial business or a business organisation that often a business organization which makes goods or services in an organized manner and sells them to the public for profit.

Further as used herein, the term “supply chain” refers to a multi-tiered network of economic entities that exchange good and services for monetary compensation. The final recipient of the supply chain is called the final consumer or a final beneficiary of the supply chain all other entities are suppliers.

Further in some embodiments, the term “consumer” may refer to a company or multiple companies which may also act as suppliers and produce and distribute a specific product or service. The supply chain includes multiple functions like product development, marketing, operations, distribution, finance, customer service, and so forth.

Referring to FIG. 1, the exemplary environment 100 includes a risk assessment system 102. The risk assessment system 102 is configured to identify one or more risks of modern slavery in at least one of operations of a company and a complete supply chain (or complete system of supply chains). The risks of modern slavery may include, but are not limited to, risks of forced labour, risks of slavery, and so forth.

The risk assessment system 102 is configured to receive a first set of inputs from one or more data sources 104 and a second set of inputs from one or more companies 106. The data sources 104 may include publicly available data sources configured to provide publicly available data to the risk assessment system 102. Examples of the first set of inputs provided by the data sources 104 may include, but are not limited to, the first set of inputs comprising at least one of Global Slavery Index estimates of a number of slaves in each country and a percentage of slaves that are forced labourers in each region, US Department of Labor findings of particular products and countries that are known to involve the use of forced or child labour, the US Department of State Trafficking in Persons (TIP) Report that categorizes countries based on their response to human trafficking, and estimates of the number of employees in each industry and the economic output of each industry in each country from a dataset such as, but not limited to an MRIO dataset. In some embodiments, the risk assessment system may receive the economic output of each industry in each country from any other data source or elsewhere.

In some embodiments, the second set of inputs includes at least one of a spend data, a portfolio investment profile dataset of at least one company of the companies 106, or any other data of the companies 106. In some embodiments, the one or more supply chain risk estimates of the modern slavery further comprises a company's suppliers/investments having the greatest risk of forced labour in their supply chain, a tier related data about one or more tier of the company's supply chain having a greatest risk of forced labour, an industry/country specific data including countries and industries having the greatest risk over the entire supply chain, and a suppliers' data about suppliers contributing to the greatest overall risks. In some embodiments, the second set of inputs may include investment portfolio, loan portfolio, or sovereign bond data of the at least one company.

The system 102 may be configured to convert the second set of inputs (i.e. the investment/loan amounts) into ‘equivalent final demand’ amounts using the publicly available datasets i.e. the first set of inputs. The non-limiting examples of the publicly available datasets may include the average annual revenue to enterprise value ratio of a given industry in a given region, the Gross Domestic Product of countries, and the total public debt of countries. Furthermore, when it is either spend dataset or investment dataset that is being converted, the system 102 may use basic price to purchasers price ratio as part of the conversion of the data to a form compatible with the MRIO table. The price to purchasers price ratios can be sourced from any suitable dataset such as, but not limited to, MRIO dataset.

The risk assessment system 102 is configured to dynamically generate a risk matrix including one or more risk estimates of modern slavery in a plurality of industries and countries based on the first set of inputs. The risk matrix may include a satellite account for the MRIO matrix (Q matrix). In some embodiments, risk assessment system 102 is configured to dynamically generate a risk matrix including one or more risk estimates of modern slavery in a plurality of industries and countries based on the first set of inputs and a manual input from a user. In alternative embodiments, the one or more risk estimates of modern slavery in different industries and countries are determined manually. The risk assessment system 102 is further configured to dynamically update the one or more risk estimates of modern slavery of the risk matrix based on one or more updates in the first set of inputs. In some embodiments, the risk assessment system 102 is further configured to extrapolate the first set of inputs to generate estimates about countries and industries with lower levels of information.

The risk assessment system 102 is configured to convert the second set of inputs i.e. the data of the company (or companies 106) into a format compatible with a multi-region input-output (MRIO) table by using a suitable method. In some embodiments, the method may include an MRIO foot printing method to a social indicator. Further, the second set of inputs may be converted into the format compatible with the MRIO table by using at least one of prorating of spend or investment amounts by industry economic output figures derived from the MRIO table, standard automated database manipulation techniques, and input-output analysis techniques. The risk assessment system 102 is further configured to generate one or more supply chain risk estimates of the modern slavery based on the generated risk matrix, the MRIO table, and formatted second set of inputs and by using one or more standard supply chain decomposition and foot printing methods. The risk assessment system 102 is further configured to present the generated one or more supply chain risk estimates of the modern slavery in one or more forms like a table, a report, a graph, a map, and so forth by using one or more colors.

In some embodiments, the risk assessment system 102 is further configured to combine one or more data inputs of the first set of inputs into a risk estimate matrix including a relative number of forced labourers in each industry and country. In some embodiments, the risk assessment system 102 is further configured to compare a forced labour risk of one or more industries in a plurality of countries based on the risk estimate matrix of the one or more industries in the plurality of countries.

In some embodiments, the risk assessment system 102 is further configured to combine one or more input data comprising an employment dataset, prevalence estimates, a government response, a product information, and an industry risk to derive a useable relative risk rating of forced labour risk for each country and industry.

In some embodiments, the risk assessment system 102 is further configured to store, update and maintain at least one of the first set of inputs, the second set of inputs, the risk matrix, the overall risk data for supply chains, the MRIO table, the employment data, the prevalence estimates, the government response, the product information, and the industry risk.

Referring now to the FIG. 2, the block diagram 200 illustrating various system elements of the exemplary risk assessment system 202 are shown, in accordance with an embodiment of the present disclosure. As shown, the risk assessment system 202 includes an input module 204, a matrix generation module 206, a slavery assessment module 208, a display module 210, and a database 212.

The risk assessment system 202 may include hardware, software, firmware and combination of these. The risk assessment system 202 may be implemented in a suitable device like a computing device or a network device like a server device, a cloud-based device, and so forth. Examples of the computing device may include, but are not limited to, a smart phone, a computer, a tablet computer, a laptop computer, a smart watch, a fitness tracker, and so forth. In some embodiments, the risk assessment system 202 may be implemented in a computing device as a mobile application. Alternatively, the risk assessment system 202 may be accessed by entering a uniform resource locator on a browsing application on the computing device via a network like internet. The non-limiting examples of the browsing application may include Internet explorer, Apple safari, Google Chrome, and so forth.

The risk assessment system 202 is configured to determine risks in a complete system of supply chains and/or operations of a company by assigning risk factors representing the likelihood of forced labour or slavery or modern slavery occurring in each industry in each country in the world; and using MRIO analysis to convert company spend dataset or portfolio investment profiles into an overall risk data for their supply chains.

The input module 204 is configured to receive at least one of a first set of inputs and a second set of inputs. The first set of inputs may include data from publicly available data sources. Examples of the first set of inputs may include, but not limited to, Global Slavery Index estimates of a number of slaves in each country and a percentage of slaves that are forced labourers in each region, US Department of Labor findings of particular products and countries that are known to involve the use of forced or child labour, the US Department of State Trafficking in Persons (TIP) Report that categorizes countries based on their response to human trafficking, and estimates of the number of employees in each industry and the economic output of each industry in each country from a dataset like from an MRIO dataset or elsewhere. The second set of inputs may include at least one of a spend dataset and a portfolio investment profile dataset of at least one company. In some embodiments, the second set of inputs may include any other suitable data of the company or companies. the second set of inputs may include investment portfolio, loan portfolio, or sovereign bond data of the at least one company.

The matrix generation module 206 may also be configured to combine one or more input data comprising an employment dataset, prevalence estimates, a government response, a product information, and an industry risk to derive a useable relative risk rating of forced labour risk for each country and industry. The matrix generation module 206 is configured to dynamically generate a risk matrix including one or more risk estimates of modern slavery in a plurality of industries and countries based on the first set of inputs. In some embodiments, the matrix generation module 206 dynamically generates the risk matrix including one or more risk estimates of modern slavery in a plurality of industries and countries based on the first set of inputs and manual inputs from a user. The one or more risk estimates of modern slavery for industries independent of country of origin may be an input received by the input module. In alternative embodiments, the estimates of the risk of modern slavery like of forced labour or slavery in different industries independent of country of origin are determined manually. The one or more risk estimates of modern slavery in different industries and countries may be determined manually. In some embodiments, the risk matrix may include a satellite account for the MRIO matrix (Q matrix).

The matrix generation module 206 is further configured to dynamically update the one or more risk estimates of modern slavery of the risk matrix based on one or more updates in the first set of inputs.

Because slavery, by its nature, is a hidden crime, it may be difficult to obtain good quality data about its prevalence in specific industries and countries. In some embodiments, the matrix generation module 206 may use reasonable assumptions to extrapolate from the known or high-quality data sources listed above to generate estimates about countries and industries with lower levels of information. The matrix generation module 206 is further configured to extrapolate the first set of inputs to generate estimates, i.e. the risk estimates, about countries and industries with lower levels of information.

In some embodiments, the matrix generation module 206 also provides a way of combining the different data sources into a single risk estimate. The matrix generation module 206 is further configured to combine one or more data inputs of the first set of inputs into a risk estimate matrix including a relative number of forced labourers in each industry and country. The matrix used is a set of numbers representing the relative number of forced labourers in each industry and country. Further, the matrix may include more than one number for each industry and country combination.

In some embodiments, the matrix generation module 206 also allows different industries in different countries to be compared on their forced labour risk. The matrix generation module 206 may compare a forced labour risk of one or more industries in a plurality of countries based on the risk estimate matrix of the one or more industries in the plurality of countries.

The slavery assessment module 208 is configured to convert the second set of inputs, i.e. the company cost and/or investment data, into a format compatible with a multi-region input-output (MRIO) table by using a suitable method. In some embodiments, the method may be an MRIO foot printing method to a social indicator. The method for converting the second set of inputs, i.e. company spend dataset or portfolio investment profiles, into overall risk data for supply chains is an application of the MRIO foot printing methodology. The spend or investment dataset is converted into a format compatible with the MRIO matrix. This process may be an automated, semi-automated process or may require a manual input. Further, the second set of inputs may be converted into the format compatible with the MRIO table by using at least one of prorating of spend or investment amounts by industry economic output figures derived from the MRIO table, standard automated database manipulation techniques, and input-output analysis techniques.

The slavery assessment module 208 is further configured to generate one or more supply chain risk estimates of the modern slavery based on the generated risk matrix, the MRIO table and formatted second set of inputs and by using one or more standard supply chain decomposition and foot printing methods. In some embodiments, the one or more supply chain risk estimates of the modern slavery comprises a percentage of the total modern slavery risk that occurs in upper tiers of the supply chain of a given industry, and a percentage of the total value chain represented by the same segment of the supply chain, data about a company's suppliers/investments having the greatest risk of forced labour in their supply chain, a tier related data about one or more tier of the company's supply chain having a greatest risk of forced labour, an industry/country specific data including countries and industries having the greatest risk over the entire supply chain, and a suppliers' data about suppliers contributing to the greatest overall risks. The one or more supply chain risk estimates may provide insight about the nature of the modern slavery risk in relation to the first-tier industry, i.e. how closely connected the first-tier industry is to modern slavery and how much leverage it has.

The slavery assessment module 208 may be configured to convert the second set of inputs (i.e. the investment/loan amounts) into ‘equivalent final demand’ amounts using the publicly available datasets i.e. the first set of inputs. The non-limiting examples of the publicly available datasets may include the average annual revenue to enterprise value ratio of a given industry in a given region, the Gross Domestic Product of countries, and the total public debt of countries. Furthermore, when it is either spend dataset or investment dataset that is being converted, the slavery assessment module 208 may use basic price to purchasers price ratio as part of the conversion of the data to a form compatible with the MRIO table. The price to purchasers price ratios can be sourced from any suitable dataset such as, but not limited to, the MRIO dataset.

The slavery assessment module 208 may also be configured to convert the second set of inputs (i.e. the investment/loan amounts) into ‘equivalent final demand’ amounts using the first set of inputs.

The display module 210 is configured to present the generated one or more supply chain risk estimates of the modern slavery including forced labour and slavery.

The database 212 may be configured to store, update and maintain at least one of the first set of inputs, the second set of inputs, the risk matrix, the overall risk data for supply chains, the MRIO table, the employment data, the prevalence estimates, the government response, the product information, the industry risk, and so forth.

Referring to the FIGS. 3A-3B, the flowchart diagram illustrating the exemplary method 300 for identifying one or more risks of modern slavery in at least one of operations of a company and a complete supply chain is shown. As discussed with reference to the FIG. 2, the risk assessment system 200 includes the input module 204, the matrix generation module 206, the slavery assessment module 208, the display module 210, and the database 212.

At step 302, a first set of inputs and a second set of inputs are received. In some embodiments, the input module 204 receives the at least one of the first set of inputs and the second set of inputs. In some embodiments, the first set of inputs may include data from publicly available data sources. Examples of the first set of inputs may include, but are not limited to, Global Slavery Index estimates of a number of slaves in each country and a percentage of slaves that are forced labourers in each region, US Department of Labor findings of particular products and countries that are known to involve the use of forced or child labour, the US Department of State Trafficking in Persons (TIP) Report that categorizes countries based on their response to human trafficking, and estimates of the number of employees in each industry and the economic output of each industry in each country from a dataset such as, but not limited to, a multi-regional input-output (MRIO) database or supply chain database. In some embodiments, the second set of inputs may include at least one of a spend dataset and a portfolio investment profile dataset of at least one company.

At step 304, a risk matrix including one or more risk estimates of modern slavery in a plurality of industries and countries is dynamically generated based on the first set of inputs. The risk matrix may include a satellite account (also known as environmental stressors or extensions) for the MRIO matrix (Q matrix). The satellite account may provide a way to link to the central accounts including national or regional accounts to allow attention to be focused on a certain field or aspect of social and life in the context of national accounts. Further, the satellite account can meet distinct data needs by providing more detail, by rearranging concepts from the central framework or by providing additional information. In some embodiments, the matrix generation module 206 dynamically generates the risk matrix including the one or more risk estimates of modern slavery including such as, forced labour, and slavery in the plurality of industries and countries based on the first set of inputs. Further, the one or more risk estimates of modern slavery of the risk matrix may be dynamically updated, by the matrix generation module, based on one or more updates in the first set of inputs. In some embodiments, the matrix generation module may extrapolate the first set of inputs to generate estimates, i.e. the risk estimates about countries and industries with lower levels of information. In some embodiments, the one or more risk estimates of modern slavery including such as, but not limited to, one or more risk estimates forced labour and slavery, in different industries (independent of country of origin) and countries are determined manually or based on manual inputs.

At step 306, the second set of inputs are converted into a format compatible with a multi-region input-output (MRIO) table. In some embodiments, the slavery assessment module 208 converts the second set of inputs into the format compatible with the MRIO table. In some embodiments, this may include an MRIO foot printing method to a social indicator. Further, the second set of inputs may be converted into the format compatible with the MRIO table by using at least one of prorating of spend or investment amounts by industry economic output figures derived from the MRIO table, standard automated database manipulation techniques, and input-output analysis techniques.

At step 308, one or more supply chain risk estimates of the modern slavery are generated based on the risk matrix, the MRIO table, and formatted second set of inputs and by using one or more standard supply chain decomposition and foot printing methods. In some embodiments, the slavery assessment module 208 generates the one or more supply chain risk estimates of the modern slavery, such as, but not limited to, of forced labour and slavery, based on the generated the risk matrix, the MRIO table, and formatted second set of inputs and by using the one or more standard supply chain decomposition and foot printing methods. In some embodiments, the matrix generation module 206 may combine one or more input data comprising an employment dataset, prevalence estimates, a government response, a product information, and an industry risk to derive a useable relative risk rating of forced labour risk for each country and industry.

Thereafter at step 310, the generated the one or more supply chain risk estimates of the modern slavery, for example one or more supply chain risk estimates of the forced labour and/or slavery in a complete system of supply chains, are presented. In some embodiments, the display module 210 presents the one or more supply chain risk estimates of the modern slavery in a complete system of supply chains on the computing device in form of reports, graphs, charts, tables, and any other representation.

Referring to the FIG. 4, an exemplary graph 400 showing risks by supplier in a supply chain (relative) is shown, in accordance with an embodiment of the present disclosure. The graph 400 shows top five suppliers of a company by total spends, categorized by their relative risk of slavery. Each supplier is assigned a risk score—estimated number of slaves per million dollars ($M) spend. All scores are then divided by the average number of slaves per $M. The graph 400 may show darker colours for the suppliers with a higher relative risk.

Referring to the FIG. 5, another exemplary graph 500 depicting risks by supplier (absolute) is shown, in accordance with an embodiment of the present disclosure. The graph 500 is identical to the Risk by Supplier (Relative) graph 400 as discussed with reference to the FIG. 4, except that the matrix used is the raw estimated number of slaves in the supply chains of each supplier. As shown, for this particular company, none of the suppliers individually have a number above one. This is due to the relatively small amounts spent and the relatively low risk industries and countries they are invested in.

Referring to the FIG. 6, another exemplary graph 600 depicting slaves and cumulative slaves by tier is illustrated, in accordance with an embodiment of the present disclosure. The graph 600 plots a number of slaves and cumulative number of slaves in a supply chain of a company by layer of supply chain decomposition. The first tier is direct suppliers of the company. The second tier represents the inputs required for each of those suppliers, and so on.

The graph 600 shows that the greatest risk of slavery occurs deeper within the supply chain than the first tier, so it is necessary to perform thorough due diligence. The graph 600 also estimates how many tiers are required before the company's leverage becomes diluted (the graph 600 begins to level out, i.e., the amounts circulating in the matrix are so small by tier 10 that very little new information is being obtained).

Though not shown, but one or more colours may also be used in the graphs 400, 500, and 600. Further, the risk assessment system of present disclosure is configured to display information by using any of the graphs 400, 500, and 600. In some embodiments, the risk assessment system is configured to show an estimated number of slaves in each country summed over the company's entire supply chain via a map. The map may display label for different countries. The risk assessment system may also identify for each country the industry with a greatest number of slaves. This may be displayed while viewing the map dynamically. The risk assessment system is configured to present quantitative and qualitative representation showing risks of modern slavery in a complete system of supply chains. The risk assessment system is configured to determine estimated number of slaves in each industry in each country. The risk assessment system is configured to determine estimated number of slaves in each company in each country. The risk assessment system is configured to determine one or more risks of modern slavery like estimated number of slaves in terms of ratings, slavery footprints.

The disclosed risk assessment system such as the risk assessment system 202 of FIG. 2 uses a method for assessing the risk of forced labour for each industry for each country worldwide based on publicly available data sources. The method may require manual estimates of the risk of forced labour in different industries independent of country of origin. The method may also include dynamically updating this risk rating. The method also uses inputs from publicly available data sources, including, but not limited to, Global Slavery Index estimates of the number of slaves in each country and the percentage of slaves that are forced labourers in each region; US Department of Labor findings of particular products and countries that are known to involve the use of forced or child labour; the US Department of State Trafficking in Persons (TIP) Report which categorizes countries based on their response to human trafficking; and estimates of the number of employees in each industry in each country from the MRIO dataset or elsewhere. Each of these sources is periodically updated as new information comes to light.

Because slavery, by its nature, is a hidden crime, it is difficult to obtain good quality data about its prevalence in specific industries and countries. For example, in Australia, the Australian Institute for Criminology estimates that there are four undetected victims of slavery in Australia for every victim that is detected. The method includes using reasonable assumptions to extrapolate from the known or high-quality data sources listed above to generate estimates about countries and industries with lower levels of information. The method also includes providing a way of combining the different data sources into a single risk estimate. The matrix used is a number representing the relative number of forced labourers in each industry and country. The method also includes allowing different industries in different countries to be compared on their forced labour risk.

The method also includes dynamically generating risk estimates based on the input data sources. This means it can produce updated estimates of slavery risk as each of the data inputs are updated. The risk matrix that is produced is called a Q matrix. The method for converting company spend dataset or portfolio investment profiles into overall risk data for supply chains may include an application of the MRIO foot printing methodology. The spend or investment dataset is converted into a format compatible with an MRIO matrix. This process is semi-automated and may require a manual input. The method further includes using standard supply chain decomposition and foot printing methods to generate supply chain risk estimates of slavery from the Q matrix the MRIO table, and the formatted spend/investment data.

Further post-processing steps—again, that are consistent with standard foot printing and supply chain decomposition methods—enable data to be collected on: which of the company's suppliers/investments have the greatest risk of forced labour in their supply chain; at what tier of the company's supply chain there is the greatest risk of forced labour; what countries and industries have the greatest risk over the entire supply chain; and the suppliers that contribute to the greatest overall risks.

This method may use the foot printing methodology (i.e. gathering information about digital systems like computers and entities associated with the digital systems) to a social indicator—forced labour risk. The primary use of the method is to allow companies to quickly prioritize their suppliers in terms of the due diligence processes that they need to undertake with respect to forced labour. It allows companies to rapidly identify the areas of their supply chains that are most likely to involve forced labour so that they can begin to employ mitigation strategies. This can be done far more rapidly than methods using product-based supply chain assessments as it relies on aggregated industry-level data rather than individual product information.

The disclosed risk assessment system identifies risks of slavery like modern slavery for various industries, companies, and countries. The risk assessment system may be used for controlling a risk level of slavery in supply chain systems. Further, the risk assessment system may be used for certifying various organizations based on risks of modern slavery/forced labour/slavery in the organizations' supply chains.

In some embodiments, the risk assessment system may be used for identifying one or more risks of modern slavery in companies having a consolidated revenue of at least fifty million AUD.

The risk assessment system may be used for determining slavery footprint in a complete supply chain system.

The disclosed risk assessment systems may determine preliminary risk for a given country-industry pair by multiplying the country ‘tier’ by the industry ‘risk’. The use of multiplication is appropriate here. The industry ‘risk’ level is similar to a probability estimate i.e. how likely is it that forced labour exists in that industry. This risk value is derived, by the risk assessment system, from review of multiple sources and discussions or inputs from experts about the relative risk of slavery in different industries. The tier for a country corresponds to the value assigned to that country in the US State Department's Trafficking in Persons (TIP) Report. This also includes an element of likelihood, but the TIP Report focuses on the steps the country is taking to address forced labour: it ‘is based not on the size of the country's problem but on the extent of governments' efforts to meet the TVPA's minimum standards for the elimination of human trafficking’ (TIP Report 2018). So, the tier rating indicates to an extent how much of a problem slavery is likely to be in the future without private sector intervention. Therefore, the multiplication method is appropriate as a way to get a preliminary estimate of risk.

The disclosed risk assessment systems may assess one or more risks of modern slavery by using data from US Department of Labour (DOL). The US Department of Labour (DOL) has a list of goods and countries where there is known and documented use of child or forced labour. The risk assessment systems determine industry-level risk by using the data from the US Department of Labour (DOL).

The risk assessment system may proportionally adjust the risk matrix based on the known presence of forced and child labour in certain products from certain countries based on the US DOL list. For example, Argentina is a tier one country, and even though Global Industry Classification Standard (GICS) industry 302020 (Food Products) is a level 5 risk industry, the overall risk for Argentina in this industry is therefore only 5. However, there are 7 different food products that have a known presence of child labour in this industry in Argentina. Based on this information, it should at least be a medium level risk. On the other hand, Turkmenistan is a tier three country, and has known child labour and forced labour in the cotton industry. There are no other goods on the list from Turkmenistan that have been identified as using forced or child labour. Therefore, it is probably not appropriate for the risk of Construction Materials (level 5) from Turkmenistan to have a risk of 15. The references to the risk level for industries independent of country of origin here are references to numbers from a dataset of categorical risk estimates of modern slavery in a plurality of industries independent of a country of origin based on manual input that may form part of the first set of inputs.

The disclosed risk assessment system may consider the appropriate weight to give a specific product within a broader industry at the level of aggregation. For example, food products is a broad category that includes a number of products that recur on the Department of Labour list in different countries, such as seafood, cattle, and coffee. But the presence of slavery in one of these products does not necessarily mean that the industry as a whole should be categorised as high risk, especially if that product represents a very small part of that country's industry. The risk assessment system may determine for the companies whose supply chains source from that country/industry, but for a completely different product within it, which may be likely, the risk may be artificially inflated.

For example, child labour has been identified in the production of ‘surgical instruments’ in Pakistan, which falls into GICS industry 351010 (Health Care Equipment & Supplies). This includes items like ‘surgical scissors’, i.e., devices used in surgery (see ILO 2002). This industry generally has a low risk level of 2, which in a Tier 2 country like Pakistan, results in a preliminary country-industry risk of 4. However, one of Pakistan's largest export industries is ‘Packaged Medicaments’, things like antibiotics, etc. The risk level for Pakistan-351010 should not be excessively raised based on identified child labour in surgical instrument manufacturing, when this will inflate the risk of other related but potentially independent supply chains drawing from Pakistan.

Finally, the risk assessment system may have a conservative design in that even if there is limited information on which to base the risk rating, if there is some indication of a moderate risk of forced labour, this should be recorded. This means that while it might be appropriate to downgrade a ‘very high’ risk level to ‘medium’ if there is no specific evidence of forced labour in a given country-industry from the DOL list, the risk assessment system should be more hesitant to downgrade a ‘medium’ risk to a ‘low’ risk.

The risk assessment system may be configured to calculate a number of products in each country-sector identified in the DOL list as having child labour or forced labour. Based on this number, the risk assessment system assesses the risk of child labour and forced labour respectively as none (0), low (1), medium (2) or high (3). These ranges may be based on the number of values in each category. These ranges are then summed together, by the risk assessment system, to get an overall ‘known risk’ level based on DOL information.

The risk assessment system may first create relative risk categories for child and forced labour and then sum the outcomes of these values; this may appropriately account for this known information without giving too much weight to specific products. Thus if ‘blueberries’ and ‘garlic’ have a risk of child labour in a given country, and there are no other known risks, food products would still be classed as ‘low’ since those two products alone are not necessarily representative of an industry-wide issue as shown in below table 1:

| Category | Child Labour | Forced Labour |
|---|---|---|
| Zero | 0 products | 0 products |
| Low - Majority of cases | 1 product | 1 product |
| Medium | 2 to 4 products | 2 products |
| High - Top 10% | 5 or more products | 3 or more products |

The risk assessment system then may multiply all risk ratings by 0.7 to produce an adjusted initial risk level. This is equivalent to reducing level 5 industry risk to level 3.5, and level 3 risk to 2.1. In a Tier 3 country, this may adjust a country-industry risk from 15 to 10.5, or from 9 to 6.3. This reflects the fact that the initial country-industry risk estimate is not based on information specific to that country-industry, but is conservative in that medium estimates are not downgraded as much as higher risks.

In some embodiments, the risk assessment system multiplies ‘known risk’ value by half the amount by which the initial risk level was reduced and which is then added to the adjusted initial risk level. This is a proportional way of factoring in known cases. Thus, if the Tier 3 country discussed above had three products where forced labour was identified and one product where child labour was identified within the food products industry, the risk level would: begin at 3×5=15; be adjusted 0.7×15=10.5; then be re-adjusted to (2+1)×(0.15×15)+10.5=17.25. This is slightly higher than the initial estimate, which is appropriate given that the initial ‘high’ assessment is supported by concrete information.

The logic of adding back a multiple of the ‘reduction’ is that, taking a conservative approach, a ‘low’ risk of child and forced labour based on known product information is sufficient to confirm the initial risk level based only on country and industry-level information. If there are a higher number of products in the country-industry identified as products of forced or child labour, then this will result in a proportional increase in the risk level instead. The final scale may begin from 0 (though in reality the minimum value is 0.7) and is capped at 20.

The risk assessment system may then convert the risk values for each industry and country to a number that better reflects the relatively likely number of slaves in high and low risk industries according to the assumptions outlined above. For example, the new risk values may be obtained using the function f(x)=1−1/x.

In some embodiments, the risk assessment system is configured for calculating number of slaves by Industry/Country. The risk assessment system calculates the number of slaves for each industry/country as follows. For countries where data on the number of full-time equivalent employees (FTEs) are available for each industry, the number of slaves is estimated by multiplying the number of FTEs by the prevalence rate for the country (from the Global Slavery Index). The prevalence is scaled up or down proportional to how the industry's risk level compares to the average industry risk level for the country. In an example, an exponential weighting may be used here. So exp(val)/exp(average). This is because otherwise the meaning of the risk values is not properly reflected in the relative number of slaves in different industries produced by the weighting process. For example, looking at Australia, lower risk values should mean very, very low prevalence rates, almost 0 slaves, and the industries with higher values should be where the risk is concentrated. For countries without FTE values, the raw number of forced labourers from the Global Slavery Index is distributed among industries for each country based on weights derived from the median FTEs per dollar in economic output in other countries and the economic output of each industry in the given country.

The risk assessment system may get ratio of risk to average risk and may take 10 to the power of this. Further, the risk assessment system may derive weights from these values so that they sum to 1. This way, the risk assessment system may determine that an industry with twice the average risk has 10 times more slaves.

Alternatively, the risk assessment system may take the average to the power of the ratio. That way, the effect of the larger overall score is preserved.

The risk assessment system then may adjust the results from using these weights so that the total number of slaves for the country matches the GSI values.

According to an embodiment of the present disclosure, the risk assessment system gets risk/priority values by country and industry, and multiply together to get preliminary ‘risk’ estimate for each country-industry pair. Then, the risk assessment system updates these values to reflect the better-quality data from the US DOL. Thereafter, the risk assessment system converts these risk values from GICS codes to the MRIO table industry classification system. Then, the risk assessment system uses an averaging procedure and the FTE data from MRIO database where it is available to convert the country-level prevalence figures of forced labour from the Global Slavery Index to figures for each country-industry pair. The resultant matrix of estimated forced labourers associated with each country-industry pair may be referred to as a satellite account for the MRIO table (Q matrix).

In some embodiments, the risk assessment system may convert the risk values from one industry classification system to another by weighting the number of slaves in the destination industry by the number of FTEs in that industry or the total economic output of that industry relative to all other industries in the same country.

Further, in some embodiments, the risk assessment system may calculate the ratio of full-time equivalent employees to economic output for each industry in each country (FTEs per output). The risk assessment system then may calculate the natural logarithm of the FTEs per output in each industry in each country. The risk assessment system then may identify industries within each country that are outliers in terms of the natural logarithm of the FTEs per output, based on standard statistical methods. The risk assessment system may adjust the FTEs per output such that the natural logarithm of FTEs per output is closer to the median by a proportional amount. The risk assessment system may create weights based on the adjusted total economic output of each industry in each country (reflecting the adjusted FTEs per output values) relative to the total economic output of each industry into which the given industry falls. The risk assessment system may also calculate the number of slaves in each industry by multiplying the number of slaves in each industry by the relevant weight linking the industries.

In some embodiments, the risk assessment system receives a spend dataset from a company and estimates the modern slavery risk associated with each supplier. The spend dataset may have GICS industry classifications and country of operation associated with each supplier.

The risk assessment system may use standard database manipulation techniques to determine the industry and country pairs from the MRIO table associated with each supplier. The risk assessment system may use prorating based on the economic output of each industry and country pair to distribute the amount spent with each supplier among the linked industry and country pairs. The risk assessment system may use a publicly available dataset to convert the amount spent from purchasers price to basic price.

The risk assessment system may use one or more standard supply chain decomposition and foot printing methods and the MRIO table to calculate the value spent in each country and industry around the world attributable to the first-tier spend with each supplier. The risk assessment system may then multiply each of these values by the relevant element of the Q matrix and the inverse of the economic output of each country and industry pair to estimate the number of forced labourers attributable to each value spent. The risk assessment system may then sum these amounts to estimate the total number of slaves attributable to the amount spent with each supplier.

The display module of the risk assessment system may then plot these results in terms of the absolute or relative number of slaves associated with each supplier. The display module may present plots ranking the suppliers by risk of modern slavery.

The disclosed risk assessment systems and methods may identify the risks of modern slavery in a complete system of supply chains without requiring companies to provide information about the precise products purchased from each supplier. The risks of modern slavery may include, but are not limited to, risks of forced labour, risks of slavery, risks of trafficking persons, risks of child labour, risks of servitude, risks of deceptive recruiting, risks of debt bondage, and so forth.

The disclosed risk assessment systems and methods may identify the risks of modern slavery in a complete system of supply chains without requiring a significant amount of proprietary information from third parties about the components of each product.

The disclosed risk assessment systems and methods may identify the risks of modern slavery in a complete system of supply chains without involving significant assumptions about the origin of product components.

The disclosed risk assessment systems and methods for identifying risks of modern slavery in a complete system of supply chains may be used to identify risks in as many tiers of the supply chain as required. In addition to the disclosed risk assessment systems and methods may make the overall supplier risk prioritization process much faster.

In some embodiments, the disclosed risk assessment systems and methods may derive input data on slavery risk and prevalence in countries and industries from publicly available data through the application of research and human rights experience. Further, the disclosed risk assessment systems and methods may use MRIO tables and satellite accounts based on national supply-use tables and international trade flows.

In some embodiments, the disclosed risk assessment systems and methods uses multi-regional input-output (MRIO) tables to perform supply chain decomposition on company spend or investment data. It then combines this with the uniquely derived rating of countries and industries for risk of forced labour (the ‘Q matrix’) to produce a footprint of forced labour across the entire supply chain.

The disclosed systems and methods use the foot printing methodology to identify a social indicator comprising a forced labour risk. The primary use of the method is to allow one or more companies to quickly prioritize their one or more suppliers in terms of due diligence processes that the one or more suppliers need to undertake with respect to forced labour.

The purpose of disclosed risk assessment systems is to provide a rapid and cost-effective estimate of the risk of forced labour in the complete supply chains of a company or investment portfolio. The system takes data on the amount spent on different products from different countries by a company, or the amount invested in different products by a company, and generates a footprint of the possible number of forced labourers enslaved in supply chains funded by the company.

The disclosed risk assessment systems and methods may also enable companies to enables companies to rank their suppliers and/or investments based on the relative risk of modern slavery in their respective supply chains; identify the ultimate countries and industries in which suppliers and investments generate the greatest risk of forced labour; and identify for each supplier or investment: at what tier of the supply chains forced labour is most likely; identify which industries and countries are most likely to contribute to this risk.

The disclosed systems and methods allow companies to rapidly identify the areas of their supply chains that are most likely to involve forced labour so that they can begin to employ mitigation strategies. This can be done far more rapidly than methods using product-based supply chain assessments as it relies on aggregated industry-level data rather than individual product information.

The disclosed risk assessment systems and methods may be used for initial modern slavery risk assessment to identify for the organization, sector and industry risks, product and service risks and entity risks of modern slavery in your operations and supply chains. The initial assessment may be provided to the organization in the form of a report and can form the basis of your identification compliance obligations under the Act. The report may also be included in the organizations Modern Slavery Statement.

An embodiment of the present disclosure provides a risk assessment system for identifying one or more risks of modern slavery in at least one of operations of a company and a complete supply chain. The risk assessment system includes an input module configured to receive at least one of a first set of inputs and a second set of inputs. The first set of inputs may include at least one of Global Slavery Index estimates of a number of slaves in each country and a percentage of slaves that are forced labourers in each region, US Department of Labor findings of particular products and countries that are known to involve the use of forced or child labour, the US Department of State Trafficking in Persons (TIP) Report that categorizes countries based on their response to human trafficking, estimates of the number of employees in each industry and the economic output of each industry in each country from a dataset such as an MRIO dataset or elsewhere, and so forth. The second set of inputs may include at least one of a spend dataset or a portfolio investment profile dataset of at least one company. The risk assessment system also includes a matrix generation module configured to dynamically generate a risk matrix based on the first set of inputs comprising one or more risk estimates of modern slavery comprising forced labour and slavery in a plurality of industries independent of a country of origin. In some embodiments, the matrix generation module generates the risk matrix including one or more risk estimates of modern slavery in a plurality of industries and countries based on manual input from a user. In some embodiments, the one or more risk estimates of modern slavery for industries independent of country of origin may be an input received by the input module. The risk assessment system also includes a slavery assessment module configured to convert the second set of inputs into a format compatible with a multi-region input-output (MRIO) table comprising overall economic inputs (expenditure) and outputs (demand) between industries and countries. The second set of inputs is converted into a format compatible with the MRIO table. In some embodiments, the second set of inputs are converted into the format compatible with the MRIO table by using at least one of prorating of spend or investment amounts by industry economic output figures derived from the MRIO table, standard automated database manipulation techniques, and input-output analysis techniques. The slavery assessment module is further configured to generate one or more supply chain risk estimates of the modern slavery based on the generated risk matrix, the MRIO table, and formatted second set of inputs and by using one or more standard supply chain decomposition and foot printing methods. The risk assessment system also includes a display module configured to present the generated one or more supply chain risk estimates of the modern slavery.

It will be understood that the devices and the databases referred to in the previous sections are not necessarily utilized together with the method or system of the embodiments. Rather, these devices are merely exemplary of the various devices that may be implemented within a computing device or the server device, and can be implemented in another device, and other devices as appropriate, that can communicate via a network to the exemplary server device.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above disclosed and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

What is claimed is:

1. A risk assessment system for identifying one or more risks of modern slavery in at least one of operations of a company and associated complete system of upstream supply chains, comprising:
an input module configured to receive at least one of a first set of inputs and a second set of inputs, wherein the first set of inputs comprises data from publicly available data sources, wherein the second set of inputs comprises at least one of a spend dataset and a portfolio investment profile dataset of at least one company;
a matrix generation module configured to dynamically generate a risk matrix comprising one or more risk estimates of modern slavery in a plurality of industries and countries based on the first set of inputs;
a slavery assessment module configured to:
convert the second set of inputs into a format compatible with a multi-region input-output (MRIO) table; and
generate one or more supply chain risk estimates of the modern slavery based on the generated risk matrix, the MRIO table, and formatted second set of inputs and by using one or more standard supply chain decomposition and foot printing methods; and
a display module configured to present the generated one or more supply chain risk estimates of the modern slavery.

2. The risk assessment system of claim 1, wherein the first set of inputs comprising at least one of Global Slavery Index estimates of a number of slaves in each country and a percentage of slaves that are forced labourers in each region, US Department of Labor findings of particular products and countries that are known to involve the use of forced or child labour, the US Department of State Trafficking in Persons (TIP) Report that categorizes countries based on their response to human trafficking, and estimates of the number of employees in each industry and the economic output of each industry in each country from a dataset.

3. The risk assessment system of claim 1, wherein the matrix generation module is further configured to dynamically update the one or more risk estimates of modern slavery of the risk matrix based on one or more updates in the first set of inputs.

4. The risk assessment system of claim 1, wherein the matrix generation module is further configured to extrapolate the first set of inputs to generate estimates about countries and industries with lower levels of information.

5. The risk assessment system of claim 1, wherein the matrix generation module is further configured to:
combine one or more data inputs of the first set of inputs into a risk estimate matrix comprising a relative number of forced labourers in each industry and country; and
compare a forced labour risk of one or more industries in a plurality of countries based on the risk estimate matrix of the one or more industries in the plurality of countries.

6. The risk assessment system of claim 1, wherein the one or more supply chain risk estimates of the modern slavery comprises a percentage of the total modern slavery risk that occurs in upper tiers of the supply chain of a given industry, a percentage of the total value chain represented by the same segment of the supply chain, a company's suppliers/investments having the greatest risk of forced labour in their supply chain, a tier related data about one or more tier of the company's supply chain having a greatest risk of forced labour, an industry/country specific data including countries and industries having the greatest risk over the entire supply chain, and a suppliers' data about suppliers contributing to the greatest overall risks.

7. The risk assessment system of claim 1, wherein:
the slavery assessment module is further configured to convert the second set of inputs into ‘equivalent final demand’ amounts using the first set of inputs; and
the matrix generation module is further configured to combine one or more input data comprising an employment dataset, prevalence estimates, a government response, a product information, and an industry risk to derive a useable relative risk rating of forced labour risk for each country and industry.

8. The risk assessment system of claim 7, wherein the slavery assessment module is configured to convert the second set of inputs into the format compatible with the MRIO table by using at least one of prorating of spend or investment amounts by industry economic output figures derived from the MRIO table, standard automated database manipulation techniques, and input-output analysis techniques.

9. The risk assessment system of claim 8 further comprising a database configured to store, update and maintain at least one of the first set of inputs, the second set of inputs, the risk matrix, the overall risk data for supply chains, the MRIO table, the employment data, the prevalence estimates, the government response, the product information, and the industry risk, wherein the risk matrix comprises a satellite account for the MRIO matrix (Q matrix).

10. The risk assessment system of claim 1, wherein the one or more risk estimates of modern slavery in different industries and countries are determined manually.

11. A method for identifying one or more risks of modern slavery in at least one of operations of a company and associated complete system of upstream supply chains, comprising:
receiving, by an input module of a risk assessment system, at least one of a first set of inputs and a second set of inputs, wherein the first set of inputs comprises data from publicly available data sources, wherein the second set of inputs comprises at least one of a spend dataset and a portfolio investment profile dataset of at least one company;
dynamically generating, by a matrix generation module of the risk assessment system, a risk matrix comprising one or more risk estimates of modern slavery in a plurality of industries and countries based on the first set of inputs;
converting, by a slavery assessment module of the risk assessment system, the second set of inputs into a format compatible with a multi-region input-output (MRIO) table;
generating, by the slavery assessment module, one or more supply chain risk estimates of the modern slavery based on the generated risk matrix, the MRIO table, and formatted second set of inputs and by using one or more standard supply chain decomposition and foot printing methods; and
presenting, by a display module of the risk assessment system, the generated one or more supply chain risk estimates of the modern slavery.

12. The method of claim 11, wherein the first set of inputs comprising at least one of Global Slavery Index estimates of a number of slaves in each country and a percentage of slaves that are forced labourers in each region, US Department of Labor findings of particular products and countries that are known to involve the use of forced or child labour, the US Department of State Trafficking in Persons (TIP) Report that categorizes countries based on their response to human trafficking, and estimates of the number of employees in each industry and the economic output of each industry in each country from a dataset.

13. The method of claim 11 further comprising dynamically updating, by the matrix generation module, the one or more risk estimates of modern slavery of the risk matrix based on one or more updates in the first set of inputs.

14. The method of claim 11 further comprising extrapolating, by the matrix generation module, the first set of inputs to generate estimates about countries and industries with lower levels of information.

15. The method of claim 11 further comprising:
combining, by the matrix generation module, one or more data inputs of the first set of inputs into a risk estimate matrix comprising a relative number of forced labourers in each industry and country; and
comparing, by the matrix generation module, a forced labour risk of one or more industries in a plurality of countries based on the risk estimate matrix of the one or more industries in the plurality of countries.

16. The method of claim 11 further comprising wherein the one or more supply chain risk estimates of the modern slavery comprises a percentage of the total modern slavery risk that occurs in upper tiers of the supply chain of a given industry, a percentage of the total value chain represented by the same segment of the supply chain, data about a company's suppliers/investments having the greatest risk of forced labour in their supply chain, a tier related data about one or more tier of the company's supply chain having a greatest risk of forced labour, an industry/country specific data including countries and industries having the greatest risk over the entire supply chain, and a suppliers' data about suppliers contributing to the greatest overall risks.

17. The method of claim 11 further comprising:
converting, by the slavery assessment module, the second set of inputs (i.e. the investment/loan amounts) into ‘equivalent final demand’ amounts using the first set of inputs; and
combining, by the matrix generation module, one or more input data comprising an employment dataset, prevalence estimates, a government response, a product information, and an industry risk to derive a useable relative risk rating of a forced labour risk for each country and industry.

18. The method of claim 17 wherein the second set of inputs are converted into the format compatible with the MRIO table by using at least one of prorating of spend or investment amounts by industry economic output figures derived from the MRIO table, standard automated database manipulation techniques, and input-output analysis techniques.

19. The method of claim 18 further comprising storing, updating and maintaining, in a database of the risk assessment system, at least one of the first set of inputs, the second set of inputs, the risk matrix, the overall risk data for supply chains, the MRIO table, the employment data, the prevalence estimates, the government response, the product information, and the industry risk, wherein the risk matrix comprises a satellite account for the MRIO matrix (Q-matrix).

20. The method of claim 19 further comprising manually determining the one or more risk estimates of modern slavery in different industries and countries.
